(19) United States
(12) Patent Application Publication
(10) Pub. No.: US 2003/0221357 A1
(43) Pub. Date: Dec. 4, 2003

(54) Method and apparatus for timing light emission from an article excited by light radiation

(76) Inventor: Kevin L. Parsons, Appleton, WI (US)

Correspondence Address: Welsh & Katz, Ltd., Eric D. Cohen, 22nd Floor, 120 South Riverside Plaza, Chicago, IL, 60606, US

(21) Appl. No.: 10/446,003

(22) Filed: May 27, 2003

Related U.S. Application Data
(60) Provisional application No. 60/386,662, filed on Jun. 4, 2002.

(51) Int. Cl. A01K 69/00; A01K 71/00; A01K 73/00

(52) U.S. Cl. 43/4.5

(57) ABSTRACT

A fishing lure and timing light system comprising, in combination a fishing lure made in part of a material capable of emitting light for a period of time after being subjected to a source of light radiation, a portable flashlight having a housing supporting a light source and a power source, and a switch operable to connect the light source to the power source to effect light radiation from the light source, at least the portion of the housing being made of substantially the same material as the light emitting material used in the lure, and the flashlight being operative to subject the lure to light radiation from the light source for a predetermined period of time so that both the lure and a portion of the flashlight housing are excited by light radiation, whereby observing a level of light emitted by the flashlight housing provides an remote indication of a corresponding level of light emitted by the fishing lure.

### CROSS-REFERENCE TO RELATED APPLICATIONS

This application claims the benefit of priority from Provisional Application Serial No. 60/386,662, entitled Method And Apparatus For Timing Light Emission From An Article Excited By Light Radiation, filed on Jun. 4, 2002. Provisional Application Serial No. 60/386,662 is hereby incorporated by reference in its entirety.

### FIELD OF THE INVENTION

The present invention relates generally to articles of manufacture that are capable of luminescence in response to light excitation, and more particularly to a method and apparatus for effecting light excitation of such articles and that enables the state of light emission from such articles to be timed and monitored from a position remote from the article.

### BACKGROUND OF THE INVENTION

Articles of manufacture are known that are capable of emitting light, generally termed luminescence, in response to excitation by light radiation. Such articles typically are made in whole or in part of a phosphorescent substance or material capable of delayed luminescence, that is, a luminescence that persists after removal of the exciting light source. Such delayed luminescence is sometimes referred to as afterglow. Such articles may also be made of a non-phosphorescent substrate or base that is painted or coated with a coating containing phosphor, or molded from a suitable plastic having a phosphor constituent mixed with the plastic substrate. The phosphor, when subjected to light radiation, shines or glows in the dark for a length of time related to the time duration of light irradiation, the particular phosphor composition, and the intensity and wavelength of the particular light charging source.

One example of the aforedescribed articles that has become popular with fishermen are fishing lures that have been painted with a phosphor coating or are molded from a plastic having a phosphor constituent mixed with the plastic. When these fishing lures are subjected to or charged by a light source, the excited phosphor creates a glow or fluorescence that may enhance the attraction of fish and, correspondingly, may improve fishing. Techniques employed to excite these lures include exposing them to sunlight, and also directing an incandescent light of a conventional flashlight or lamp on the lures.

A major disadvantage of known techniques for charging or exciting phosphor coated or impregnated fishing lures is that they fail to provide any indication of the state of the radiation charge imparted to the lure. Thus, once a lure is charged, it must be pulled from the water to determine if it is still charged sufficiently to provide the desired luminescence. Accordingly, it follows that a light source for exciting or charging an article of manufacture having a phosphor component by light radiation, such as a fishing lure adapted to absorb light radiation and emit a luminescent light or glow after the charging radiation has ceased, and which light source is capable of providing a time indication of substantially when the luminescence charge on the article has dissipated, would provide a significant advantage over known light radiation techniques employed to charge phosphorescent articles. This is particularly applicable to articles such as fishing lures where it is desirable to provide an indication of the expiration of luminescent light emission at a location remote from the irradiated lure.

### BRIEF SUMMARY OF THE INVENTION

One of the objects of the present invention is to provide a system for timing the length of light irradiation induced luminescence from an article capable of absorbing radiation from a light source.

Another object of the present invention is to provide a method for determining the state of light emission from an article adapted to emit luminescent light when excited by light radiation.

A still further object of the present is to provide a system for effecting light excitation of an article adapted to emit light when excited by light radiation, the system including a miniature flashlight having a light emitting diode light source operative to emit light of predetermined wavelength so as to optimize irradiation of, and light emission from the article.

A feature of the present invention lies in the provision of a miniature flashlight that may be readily carried on one's person and that employs a light emitting diode operative to emit a blue light wavelength for light irradiation of a fishing lure or the like having a phosphor coating or internal phosphor constituent.

Still another object of the present invention is to provide a fishing lure and timing light system that includes a fishing lure made at least in part of a material, or having a coating, capable of emitting light for a period of time after being subjected to a source of light irradiation, and a flashlight having a light emitting diode light source, a power source and a switch operable to connect the light source to the power source so as to effect light radiation from the light source, at least the portion of the housing supporting the light emitting diode being made of substantially the same material as the light emitting material or coating used in the fishing lure so at least the diode supporting portion of the housing absorbs light radiation and emits light for the same period of time as the charged fishing lure.

Yet another object of the present invention is to provide a miniature flashlight having a light emitting diode operative to emit light having a wavelength in the blue light spectrum, at least a portion of the flashlight being made of a material having a phosphor constituent adapted to be excited by light radiation from the light source so that observing the termination or reduction of light emission from the flashlight housing provides an indication that the light emitted by an article in response to light irradiation of the article by the light source of the flashlight has terminated or has been reduced so as to require re-excitation by light irradiation.

Further objects, features and advantages of the invention will become apparent from the following detailed description of the invention when taken in conjunction with the accompanying drawings wherein like reference numerals designate like elements throughout the several views.

### BRIEF DESCRIPTION OF THE DRAWINGS

FIG. 1 is a side elevational view of a miniature flashlight constructed in accordance with one embodiment of the present invention;

FIG. 2 is a prospective view showing the opposite side of the miniature flashlight illustrated in FIG. 1;

FIG. 3 is a front end view of the flashlight illustrated in FIGS. 1 and 2;

FIG. 4 is a bottom edge view of the flashlight of FIGS. 1 and 2;

FIGS. 5 and 6 are enlarged perspective views of an article of manufacture in the form of a fishing lure having a phosphor coating or phosphor constituent in accordance with the present invention;

FIG. 7 is a pictorial illustration showing light irradiation the fishing lure of FIGS. 5 and 6 using the miniature flashlight of FIGS. 1 and 2; and

FIG. 8 is a pictorial illustration showing operational use of the fishing lure of FIGS. 5 and 6.

### DETAILED DESCRIPTION OF THE INVENTION

In this written description, the use of the disjunctive is intended to include the conjunctive. The use of definite or indefinite articles is not intended to indicate cardinality. In particular, a reference to “the” object or thing or “an” object or “a” thing is intended to also describe a plurality of such objects or things.

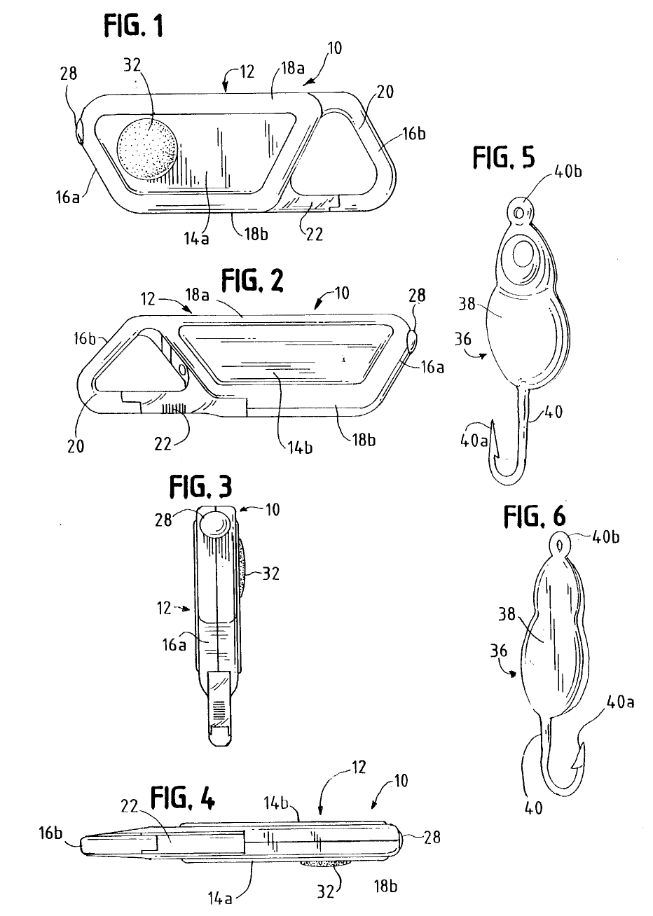

Referring now to the drawings and in particular to FIGS. 1-4, a miniature flashlight constructed in accordance with a preferred embodiment of the invention is indicated generally at 10. The flashlight 10 is similar in construction to the miniature light emitting diode flashlight disclosed in U.S. Pat. Nos. 6,190,018 (“the '018 patent”) and 6,357,890, and U.S. application Ser. No. 10/066,554, filed Jan. 31, 2002, all of which are assigned to the assignee of the present invention and are incorporated herein by reference. To this end, the flashlight 10 includes a housing 12 having a generally parallelogram shaped peripheral edge profile and is relatively miniature in size so as to be readily held in the palm of one's hand. The housing 12 has a pair of oppositely facing side panels or walls 14a and 14b, a pair of opposite ends 16a and 16b, and upper and lower edge surfaces 18a and 18b. The end 16b of the housing 12 defines a keyring extension formed integral with the housing 12 and defines in part the periphery of a generally triangular opening 20 accessible through a keyring lock 22 hinged to the housing 12, as is known.

As described in the '018 patent, the miniature flashlight 10 supports a light source in the form of a light emitting diode (LED) 28 preferably at an upper corner of the housing, as illustrated in FIGS. 1 and 2, so that the housing at least partially encloses the LED. The housing 12 further supports a power source internal to the housing that may comprise any type of battery supply with sufficient power to energize the light source, such as a pair of disc-type batteries having flat oppositely disposed sides. Preferably, the power source is comprised of two 3-volt coin type lithium cell batteries that are supported within a power source frame (not shown) internal to the housing 12.

The LED 28 preferably emits blue light, although the present invention may be carried out with any LED emitting a suitable wavelength of light. As will be described, a blue light LED light provides the desired wavelength for irradiating a phosphor coated article or an article having a substrate that includes phosphorus as a constituent. Most phosphors in luminescent light emitting applications are stimulated or charged only by short wavelength light sources, such as light sources emitting blue to far ultraviolet wavelength light. The blue LED, although producing most of its emission in the visible blue wavelength spectrum, produces a significant light energy level in the invisible or poorly visible shorter wavelengths, and is highly effective in light irradiation of phosphor materials. It has been found that an excellent stimulus for articles coated with a phosphor-containing coating are true ultraviolet LEDs because most of their energy is contained in short wavelength ultraviolet to far ultraviolet invisible light. This is contrasted with white light sources, such as incandescent lamps that emit very little short wavelength light. Thus, the light emission from white light sources contains virtually no ultraviolet light and only an insignificant amount of visible blue wavelength light.

The housing 12 also supports an internal switch structure, such as disclosed in the aforementioned '018 patent, which includes a switch button 32 supported on the housing 12 so as to extend slightly outwardly from sidewall 14a. The switch button can be depressed to connect the LED light source 28 to the battery power source during depression of the switch button, thus enabling the operator to determine the time period in which the LED 28 emits light.

In its preferred embodiment the housing 12 of flashlight 10 is made of a plastic material commercially available under the trade name Permaglow from Hirotec Engineering Co., Santa Ana, Calif. However, any suitable plastic and/or phosphorous material may be used. The housing 12 is preferably made of a material having a mixture ratio of approximately about 5-15 parts clear plastic pellets to one part glow material, and preferably a mixture approximately 10-13 parts clear plastic pellets to one part phosphor glow material, based on a thickness of material of approximately 0.125 inch. It has been found that this mixture may be subjected to light radiation to effect a glow or luminescent light emission for a period of approximately two to four hours. As mentioned above, this duration of light emission is most effectively established when the LED light source 28 produces a light source rich in the wavelengths of blue, violet, and ultra-violet light. It has also been found that the desired luminescent glow of at least the portion of the housing 12 adjacent the LED light source 28 is achieved when luminescent colorants are added to the plastic of the housing 12. For example, adding a luminescent colorant additive selected from the group consisting of aluminum oxide, strontium oxide, calcium oxide, europium oxide, and boron oxide to the plastic material of housing 12 significantly enhances the luminescent responsive to radiation from the LED 28.

The housing 12 differs from the housing disclosed in the '018 patent by having the side walls or panels 14a and 14b formed integral with the housing and from the same plastic material having a phosphor constituent added or disbursed therein. Alternatively, the housing 12 may comprise a power source frame housing that is adapted to support side panels in the manner disclosed in the '018 patent. To this end, the housing 12 may comprise a two-piece construction as disclosed in the '018 patent. With the latter construction, the side panels may be made of a material different from the material from which the power source frame housing is made, such as being made from an anodized aluminum.

As described above, the flashlight 10 is operative to effect light irradiation of an article adapted to emit light when excited by light radiation. In the illustrated embodiment, such an article may comprise a fishing lure 36, as illustrated in FIGS. 5 and 6. The fishing lure 36 includes a selectively shaped body 38 in which is embedded a fishing hook 40 having a barbed end 40a extending from the rear end of the body, and an eyelet end 40b extending from the forward end of the lower body for attaching the lure to a fishing line.

The fishing lure body 38 may be made of a plastic material having a phosphor constituent similar to the material from which the flashlight housing 12 is made, thus being adapted to emit light when excited by light radiation. Alternatively, the fishing lure may comprise a solid substrate, such as clear plastic or other desired material, and have a coating applied thereto that includes phosphor adapted to the excited by light radiation from the LED light source 28 of the flashlight 10 so as to emit luminescent light after being excited by light radiation. With the fishing lure 36 being made at least in part of a material capable of emitting light for a period of time after being subjected to a source of light radiation, such as the blue wavelength light emitted by the LED light source 28, subjecting the fishing lure to light radiation from LED 28 for a predetermined period of time causes both the fishing lure and at least the portion of the flashlight housing 12 supporting and adjacent the light source 28 to be excited by substantially the same light radiation from the light source.

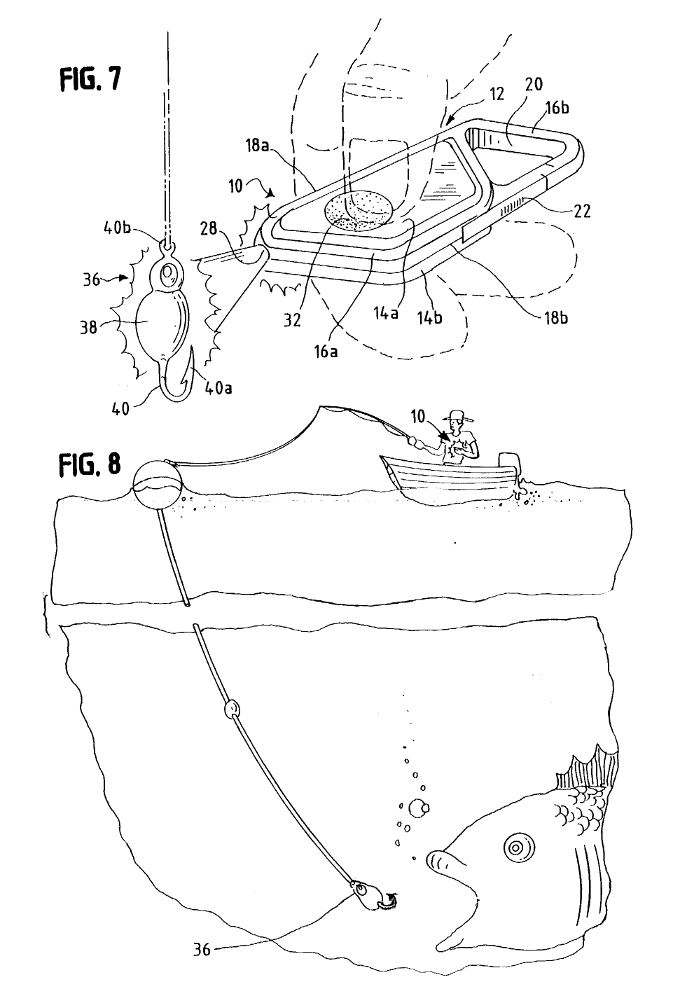

Note that the fishing lure and the material of the flashlight housing 12 at least adjacent the LED light source 28 have substantially the same light emitting properties because they are formed of or incorporate similar material, or at least material having the same or similar photo-luminescent properties. As shown in FIG. 7, when the LED 28 is energized by using finger pressure to depress the switch button 32, the light radiation emitted by the LED 28 simultaneously irradiates the fishing lure 36 and the flashlight housing 12, and irradiates both for the same duration. Although the fishing lure body 38 is irradiated directly by the LED 28, while the flashlight housing 12 is mostly irradiated indirectly due to reflection and “side-scatter” of light through the LED 28, the amount of light reaching the fishing lure body and the flashlight housing is sufficient to fully charge each portion. Thus, the fishing lure body 38 and the flashlight housing 12 each will re-radiate light or “luminesce” for about the same period of time, and the level of luminescent light will decay or reduce at about the same rate.

The amount of time that the fishing lure body 38 and the flashlight housing 12 will continue to emit light after being fully charged depends several factors, such as 1) the specific type of luminescent material used, 2) the concentration of such light-emitting material to inert material (which may be expressed as a ratio of light emitting material to non-light emitting material), 3) the length of time to which articles are subjected to the source of light, 4) the intensity of the light source to which the articles are subjected, and 5) the frequency of the light source to which the articles are subjected. The fishing lure body 38 and the flashlight housing 12 may be irradiated, for example, by using the type of LED described in the flashlight of the '018 patent, for an appropriate period of time governed by the above-mentioned factors, to fully “charge” the light emitting material forming the component or incorporated therein. The fishing lure body 38 and the flashlight housing 12 will then emit light for a period of time, again governed by the above-mentioned factors until the level of light falls to a subjectively low level. Such a subjective level is the level that the user deems the fishing lure to be ineffective or otherwise undesirable in attracting fish. This subjective level may vary widely.

After the fishing lure 36 has been charged or irradiated by energizing the LED 28, the fishing lure may be submerged into a stream, lake, or other body of water for fishing, as shown in FIG. 8. By observing the level of light being re-emitted from the flashlight housing material adjacent the light source 28, the user may determine when the luminescent light emitted by the fishing lure 36 has ceased or decreased to a sufficiently low level, such as the twenty-five percent level mentioned above, so as to require removal of the fishing lure from the water and re-excitation by light radiation from the flashlight LED 28. Accordingly, the luminescent light emitted by the flashlight housing 12 essentially provides an indication of the time duration of light emission or luminescence of the fishing lure 36 at a location remote from the fishing lure when the fishing lure is beneath the surface of the water, thus providing a visual indication of the need to recharge the fishing lure by light re-excitation.

Also note that as a convenience to the user, the keyway extension 16b of the flashlight 10 in association with the keyring lock 22 permits the flashlight to be readily attached to one's clothing, such as a fishing vest, shirt, or other article of clothing within eye observation to permit the light excitation of the fishing lure to be readily monitored.

Note that in accordance with an alternate embodiment of the present invention, the flashlight housing 12 need not be formed of a luminescent material. Rather, the fishing lure 36 itself need only be formed of such luminescent material. As mentioned above, the fishing lure 36 may be made at least in part of a material capable of emitting light for a period of time after being subjected to a source of light radiation. Preferably in this embodiment, the fishing lure 36 may be subject to illumination by a blue LED-type light source, such as the light source described in the '018 patent. In this specific embodiment, the fishing lure 36 may be subject to light radiation from the light source 28 for a predetermined period of time so that the fishing lure will continue to re-emit light for a predetermined period of time. For example, the fishing lure 36 may be subject to the light from the light source as described above, and will continue to re-emit light thereafter for a period of time. Further, the light re-emitted by the fishing lure will reduce or decay at a known rate, of course depending upon factors previously mentioned. Thus, the user of the fishing lure may estimate the length of time before the level of reemission of light from the fishing lure falls to a sufficiently low level, for example, to a “twenty-five” percent level, as mentioned above. At that point, the user may retrieve the fishing lure 36 from the water and re-illuminate it to fully “charge” its light emitting capacity.

Specific embodiments of a method and apparatus for timing light emission from an article excited by light radiation according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

What is claimed is:

1. A method for determining a level of light emission from an article adapted to re-emit light after excitation by light radiation, the method comprising:
providing an article made at least in part of a material capable of emitting light for a period of time after being subjected to a source of light radiation;
providing a flashlight having a housing supporting a light source and a power source, and a switch operable to connect the light source to the power source to effect light radiation from the light source, at least the portion of the housing being made of or incorporating substantially the same material as the light emitting material used in the article;
subjecting the article to light radiation from the light source for a predetermined period of time so that both the article and a portion of the housing are excited by light radiation; and
observing the termination or reduction of light emission from the flashlight housing as an indication that the light emitted by the article has correspondingly terminated or reduced so as to require re-excitation by light radiation.

2. The method as defined in claim 1 wherein the light source comprises a light emitting diode.

3. The method as defined in claim 2 wherein the light emitting diode emits blue light

4. The method as defined in claim 2 wherein the light emitting diode emits short-wavelength light.

5. The method as defined in claim 1 wherein the article comprises a fishing lure.

6. The method as defined in claim 1 wherein at least a portion of the flashlight housing is made of a material substantially the same as the light emitting material used in the article.

7. The method as defined in claim 1 wherein the flashlight housing incorporates a light emitting material substantially the same as the light emitting material incorporated in the article.

8. The method as defined in claim 1 wherein the article is made of a material comprising thirteen parts plastic to one part glow material capable of emitting light after being subjected to light radiation.

9. The method as defined in claim 8 wherein at least a portion of flashlight housing and/or a portion of the article are made of a luminescent colorant selected from the group consisting of aluminum oxide, strontium oxide, calcium oxide, europium oxide and boron oxide.

10. The method as defined in claim 1 wherein the step of subjecting the article to light radiation from the light source includes determining the light excitation charge applied to the article in accordance with parameters selected from the group consisting of a length of time that the article is irradiated, an intensity of the light source, a frequency of the light source, and a concentration of light emitting material contained in the article.

11. The method as defined in claim 1 wherein at least a portion of the article is made of a luminescent material, and at least a portion of the housing is made of a luminescent material.

12. The method as defined in claim 1 wherein at least a portion of the article is made of a luminescent material, and at least a portion of the housing is made of the same luminescent material.

13. The method as defined in claim 1 wherein the flashlight includes means enabling attachment of the flashlight to the user's clothing in a position capable of being visually observed so as to provide an indication to the wearer of the flashlight that the light emitted by the article has fallen below a predetermined level as a function of the light emitted from the portion of the flashlight housing.

14. The method as defined in claim 1 wherein a portion of the flashlight housing adjacent the light source is irradiated by the light source.

15. The method as defined in claim 14 wherein the portion of the flashlight adjacent the light source is irradiated in part by light reflected back from the article.

16. The method as defined in claim 14 wherein the portion of the flashlight adjacent the light source is irradiated by light passing through side portions of the light source.

17. A fishing lure and timing light system comprising, in combination:
a fishing lure made at least in part of a material capable of emitting light for a period of time after being subjected to a source of light radiation;
a portable flashlight having a housing supporting a light source and a power source, and a switch operable to connect the light source to the power source to effect light irradiation from the light source, at least the portion of the housing being made of substantially the same material as the light emitting material used in the lure; and
the flashlight being operative to subject the lure to light radiation from the light source for a predetermined period of time so that both the lure and a portion of the flashlight housing are excited by light radiation, whereby observing a level of light emitted by the flashlight housing provides a remote indication of a corresponding level of light emitted by the fishing lure.

18. The system as defined in claim 17 wherein the light source is a light emitting diode.

19. The system as defined in claim 18 wherein the light emitting diode emits blue light.

20. The system as defined in claim 17 wherein at least a portion of the housing is made of a material substantially the same as the light emitting material used in the fishing lure.

21. The system as defined in claim 17 wherein the housing incorporates a light emitting material substantially the same as the light emitting material incorporated in the fishing lure.

22. The system as defined in claim 17 wherein the fishing lure is made of a material comprising thirteen parts plastic to one part glow material capable of emitting light after being subjected to light radiation.

23. The system as defined in claim 22 wherein at least a portion of housing and/or a portion of the fishing lure are made of a luminescent colorant selected from the group consisting of aluminum oxide, strontium oxide, calcium oxide, europium oxide and boron oxide.

24. The system as defined in claim 17 wherein the step of subjecting the fishing lure to light radiation from the light source includes determining the light excitation charge applied to the lure in accordance with parameters selected from the group consisting of a length of time that the lure is irradiated, an intensity of the light source, a frequency of light emitted by the light source, and a concentration of light emitting material contained in the lure.

25. The system as defined in claim 17 wherein at least a portion of the lure is made of a luminescent material, and at least a portion of the housing is made of a luminescent material.

26. The system as defined in claim 17 wherein at least a portion of the fishing lure is made of a luminescent material, and at least a portion of the housing is made of the same luminescent material.

27. The system as defined in claim 17 wherein the flashlight includes means enabling attachment of the flashlight to the user's clothing in a position capable of being visually observed so as to provide an indication to the wearer of the flashlight that the light emitted by the fishing lure has fallen below a predetermined level as a function of the light emitted from the portion of the flashlight housing.

28. The system as defined in claim 17 wherein a portion of the housing adjacent the light source is irradiated by the light source.

29. The system as defined in claim 28 wherein the portion of the flashlight adjacent the light source is irradiated in part by light reflected back from the fishing lure.

30. The system as defined in claim 28 wherein the portion of the flashlight adjacent the light source is irradiated by light passing through side portions of the light source.

31. A timing light for subjecting a fishing lure to light radiation, the fishing lure being made at least in part of a material capable of emitting light after being subjected to light radiation, the timing light comprising a hand-holdable housing at least partially enclosing a light source, a power source, and a switch operable to connect the light source to the power source to effect light radiation from the light source, at least a portion of the housing being disposed adjacent the light source and being made of a material substantially similar to the material of the fishing lure so as to be also subjected to light radiation from the light source, whereby light re-emitted by a portion of the housing adjacent the light source provides a remote indication of the level of light emitted by the lure.

32. A method for permitting re-emission of light from a fishing lure comprising:
providing a fishing lure made at least in part of a material capable of emitting light for a period of time after being subjected to a source of light radiation;
providing a flashlight having a housing supporting a light source and a power source, and a switch operable to connect the light source to the power source to effect light radiation from the light source, the light source being a blue LED-type light source;
subjecting the fishing lure to light radiation from the light source for a predetermined period of time so that the fishing lure is excited by light radiation, the fishing lure continuing to re-emit light for a predetermined period of time, said re-emission of light reducing at a known rate; and
estimating a reduction of the light re-emission using the known rate of reduction, and re-illuminating the fishing lure with the light source after the reduction of the light re-emission has fallen below a predetermined level.
